(19) United States
(12) Patent Application Publication
(10) Pub. No.: US 2025/0186914 A1
(43) Pub. Date: Jun. 12, 2025

(54) PROTECTIVE INSULATIVE ENCLOSURES

(71) Applicant: Cindy L. Esplin, North Ogden, UT (US)

(72) Inventor: Cindy L. Esplin, North Ogden, UT (US)

(21) Appl. No.: 18/974,369

(22) Filed: Dec. 9, 2024

Related U.S. Application Data
(60) Provisional application No. 63/608,557, filed on Dec. 11, 2023.

(51) Int. Cl. B01D 35/31; B01D 46/00

(52) U.S. Cl. CPC B01D 35/31; B01D 46/0091; B01D 2201/307; B01D 2265/028; B01D 2273/20

(57) ABSTRACT

Described herein are examples of protective insulative enclosures which include a housing, comprising a sleeve, and a strap. The sleeve may be configured to envelop a filter, enclosing the filter. The sleeve comprises an insulated material. The strap may be coupled to the sleeve and is configured to prevent inadvertent dislodgment of the sleeve from the filter. The strap may be further configured to securely fasten the protective insulative enclosure to a vehicle body by attaching it to a specific part of the vehicle body.

### CROSS-REFERENCES TO RELATED APPLICATIONS

The present invention claims the benefit of prior filed U.S. Provisional Application No. 63/608,557, filed on Friday, Dec. 8, 2023, under 35 U.S.C. § 119(e)(3) and incorporates the same by reference herein in its entirety.

### FIELD OF THE INVENTION

The present invention relates to the field of filtration and more particularly relates to a protective and insulative enclosures designed to envelop filters to shield them from the localized environment and, where appropriate, inhibit incidence of temperature related changes to a physical state of filtered material.

### BACKGROUND

In filtration systems, filters play a crucial role in technology by selectively getting rid of impurities from fuel, water, air, and other useful fluids used in many different processes, including internal combustion engines. These filters use different techniques or processes like physical screening, absorption, condensation, or chemical reactions to catch and remove contaminants, ensuring that the filtered substance is free of impurities which would either hinder later processes or increase wear on downstream mechanical systems. Filters are typically placed between a source or reservoir and the component which actually needs the filtered substance. As many systems, like for engine lubrication, re-circulate used fluid after use, it can be said that “between” refers to a location after fluid leaves the source or reservoir and before its reuse. However, ultimate placement of a filter will be determined by what makes sense in the system. Filters may be positioned before a fluid enters a system or after use and before returning to a reservoir, or after use during a purge, as the system specifications require.

In the context of internal combustion engines, filters are commonly used to clean oils and fuel before used by the engine or other components. Typical filters in a vehicle include fuel filters, air filters, oil filters, transmission filters, and others. One type of air filter used in compressed air systems, which often power a larger vehicle's braking system, is called an “air dryer.” The purpose of this filter is to separate water and fuel vapors from air (“drying the air”) in the compression system to prevent damage to brakes or other pneumatic systems. These air dryers are typically placed in the closed system after the air compressor and present themselves as a removable canister containing the filter component, much like oil and fuel filters. These removable filters are founded on the premise that proper maintenance of the fluid extends the life of the working components, and the filters are a lower cost, easily replaceable, protection component that furthers this goal.

Unfortunately, as filters are typically positioned and manufactured for easy replacement, it makes sense that these filter components will be more exposed to the elements than other engine components. In the context of a vehicle, such as a diesel-powered truck tractor or semi-truck, these components may be damaged by road debris and, especially in the case of fuel and oil filters, left exposed to temperatures outside of operable ranges. In the case of temperature exposure, diesel fuel will begin to freeze at 32° F. (0° C.) and will begin to gel at 15° F. (−9.5° C.). Once gelled, the diesel fuel clogs the engine fuel system, making engine start impossible. The main culprit in gelling episodes is the fuel filter, so what often happens is that a trucker will be stranded at a truck stop and find the rig has gelled up. The trucker must then call a mechanic to replace the filter, which otherwise might still have been a good filter. Once gelled, there is no recovery for a filter. Either scenario represents lost time and money to the trucker. Similarly, road debris may damage any exposed filter, causing breakdown and a similar wait for a mechanic.

At the same time, filter covers have been developed to shield filters in various environments. Specifically, filter covers differ in materials, attachment components, and protective features and are adaptable to different environmental conditions. Most commercially available covered are powered, with a low-voltage heating line to keep the temperature of fuel present in a fuel filter warmer and prevent freezing and gelling. However, such devices require a constant power supply when the vehicle is not running. They also provide minimal protection from debris and prove difficult to install.

Identifying these challenges in current filtration systems underscores opportunities for innovation. Addressing issues such as temperature-related inefficiencies presents an opportunity to enhance the overall performance and durability of filters in internal combustion engines.

Opportunities also exist to optimize the attachment methods of protective insulative enclosures, ensuring both security and adaptability in diverse environmental conditions.

### SUMMARY OF THE INVENTION

Implementations of protective insulative enclosures may offer solutions to some or all of the challenges described above. An improved protective insulative enclosure could integrate innovative insulation methods, protective measures against extreme temperatures, and optimized attachment mechanisms. For instance, a protective insulative enclosure may be designed to encase the filter with added insulation, providing protection against both cold and hot temperature extremes. Additionally, introducing adjustable and secure attachment mechanisms could enhance the versatility and reliability of the protective insulative enclosure in diverse operating conditions. Insulative materials may also provide a cushioning effect to blunt impacts from road debris.

The disclosed embodiments in this patent application address the identified problems and opportunities by introducing innovations in protective insulative enclosure technology. By incorporating advanced insulation methods and secure attachment mechanisms, the disclosed embodiments aim to improve the overall efficiency and durability of filtration systems in internal combustion engines. These innovations contribute to the optimization of filter performance in various environmental conditions, addressing the challenges identified in conventional filter systems while leveraging opportunities for enhanced functionality.

The more important features of the invention have thus been outlined in order that the more detailed description that follows may be better understood and in order that the present contribution to the art may be better appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions as far as they do not depart from the spirit and scope of the present invention.

### BRIEF DESCRIPTION OF THE DRAWINGS

The present description will be understood more fully when viewed in conjunction with the accompanying drawings of various examples of protective insulative enclosures. The description is not meant to limit the protective insulative enclosures to the specific examples. Rather, the specific examples depicted and described are provided for explanation and understanding of protective insulative enclosures. Throughout the description the drawings may be referred to as drawings, figures, and/or FIGS.

FIG. 1 is a front perspective view of an assortment of filters with protective insulative enclosures sized to fit thereon.

FIG. 2 is a front perspective view, in partial section, of a single protective insulative enclosure and a contained fuel filter, according to an embodiment.

FIG. 3 is a top plan view of the protective insulative enclosure of FIG. 2.

FIG. 4 is a front perspective view of the protective insulative enclosure of FIG. 2 and a strap loosened from the protective insulative enclosure.

FIG. 5 is a perspective view of the protective insulative enclosure of FIG. 2, and its associated filter, installed in an environment.

FIG. 6 is a front perspective view of an alternate protective insulative enclosure and a filter adjacent to it.

FIG. 7 is a front perspective view of an alternate embodiment of a protective insulative enclosure, before installation over an air dryer.

FIG. 8 is a front perspective view of the protective insulative enclosure of FIG. 7, installed.

FIG. 9 is a bottom plan view of a further alternate embodiment of a protective insulative enclosure.

FIG. 10 is a front perspective view of the a protective insulative enclosure of FIG. 9, installed.

FIG. 11 is a bottom perspective view of the a protective insulative enclosure of FIG. 9, installed.

### DETAILED DESCRIPTION

A protective insulative enclosure as disclosed herein will become better understood through a review of the following detailed description in conjunction with the figures. The detailed description and figures provide merely examples of the various embodiments of protective insulative enclosures. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein. Reference numerals common to the Figures represent that same feature or component throughout the same.

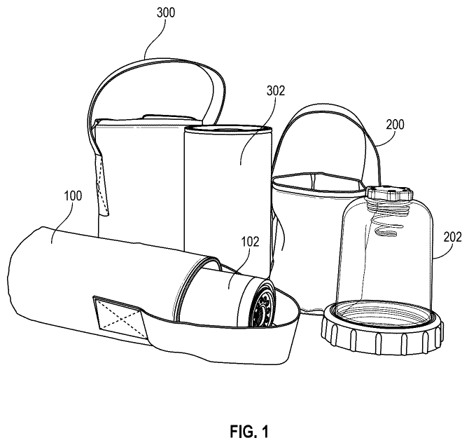

As used in this Specification, the term “filter” means any suitable filtration device, including but not limited to diesel filters, air filters, oil filters, fuel filters for gasoline engines, and air dryers. The term is used broadly to refer to any filter designed or configured to remove impurities or particles from a liquid or gas medium in various applications and industries. An assortment of filters 102, 202, 302, are shown in FIG. 1 with matching covers 100, 200, 300. As can be readily seen, filter covers are manufactured to fit on a particular size of filter, and such variations are well within the scope of the invention.

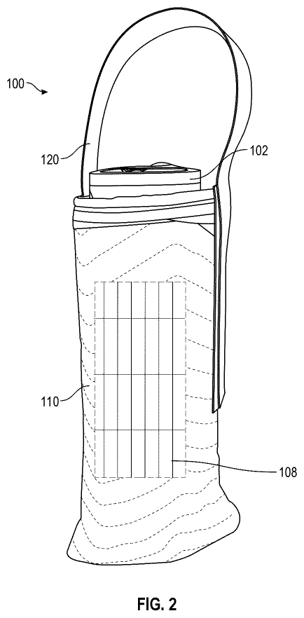

FIG. 2 illustrates a front perspective view of a protective insulative enclosure 100 and a fuel filter 102. The protective insulative enclosure 100 protects the filter 102 from extreme temperatures and enhances its durability and functionality under a spectrum of challenging environmental conditions. According to various embodiments, the protective insulative enclosure 100 may include a protective housing, comprising a capped sleeve 110, and a strap 120 coupled to the sleeve 110.

The sleeve 110 may be constructed with a padded and/or insulated material. The sleeve 110 may include a flexible and elastic material, such as neoprene or silicone, configured to conform to the contours of various filter shapes. For instance, in the case of cylindrical fuel filters commonly found in automotive applications, the flexibility of the material allows the sleeve 110 to snugly wrap around the filter, creating a tight seal. Similarly, for rectangular or square-shaped filters utilized in industrial settings, the elastic nature of the sleeve material enables it to adapt to the specific dimensions of the filter. Likewise, for these filters, the sleeve may be made in a rectangular, or any, shape to better accommodate non-cylindrical filters The adaptability of the sleeve 110 may be configured to effectively insulate the filter 102 by minimizing gaps or air pockets that could compromise the efficiency of the protective insulative enclosure 100.

The sleeve 110 may also include an adjustable structure, allowing it to fit filters of different sizes and dimensions. The adjustable structure may incorporate straps equipped with adjustable buckles, enabling users to modify the length and tightness of the strap 120. Additionally, the protective insulative enclosure 100 may include a clasp or fastening component coupled to the sleeve 110 that can be repositioned or expanded to accommodate larger filters or tightened to fit smaller ones. The modular nature of the adjustable structure may enable users to customize the configuration of the protective insulative enclosure 100, making it suitable for a variety of applications.

The sleeve 110 of the protective insulative enclosure 100 may be constructed from a variety of materials and layer structures configured to provide insulation and protection for the enclosed filter 102, particularly in the face of extreme or fluctuating temperature conditions. For example, to withstand the elevated temperatures generated during engine operation, the sleeve 110 may include heat-resistant materials, such as heat-resistant polymers or ceramic blends, to insulate and protect the filter 102 in high-temperature environments, thereby preventing deformation or deterioration of the filter 102. Moreover, the sleeve 110 may include a resilient framework 108 made of robust materials like reinforced plastics or metal alloys as a reinforcing structure to add to the integrity of the protective insulative enclosure 100, making it more resilient to impacts and environmental stressors. This resilient structure may be positioned within the sleeve 110 (as shown) or immediately upon an inner or outer surface thereof.

The sleeve 110 may include one or more layers of insulating materials. The insulating layers may include foam or thermal barriers, which may be strategically placed to minimize heat loss and protect the enclosed filter 102 against freezing temperatures. This insulation ensures that the filter 102 remains effective in cold climates, preventing the formation of ice or frost on the filter surface. Furthermore, the sleeve 110 may be constructed from weather-resistant materials, such as UV-resistant polymers or corrosion resistant metals, making the protective insulative enclosure 100 suitable for prolonged exposure to diverse climatic conditions.

The materials used to construct the sleeve 110 are not limited to the examples mentioned above. Various padded and insulated materials are suitable for protecting filters. For example, the sleeve 110 may include neoprene foam, closed-cell foam materials or polyester fiberfill for preventing moisture absorption while providing insulation and cushioning. Additional materials include foam rubber which may be used for both padding and insulation and/or reflective insulation, including aluminum foil-backed materials, to reflect heat away. Closed-cell polyethylene foam may also be used for durable, moisture-resistant, and effective insulation.

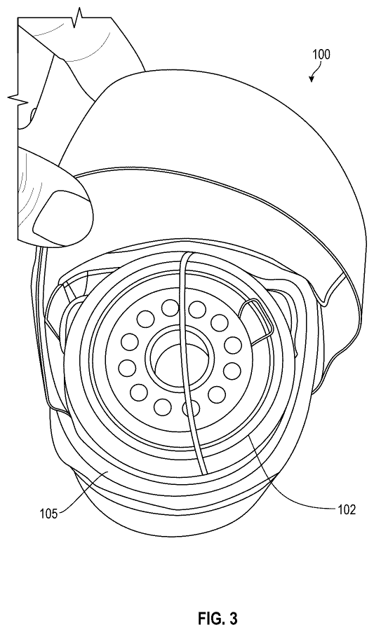

FIG. 3 illustrates a top-down view of a protective insulative enclosure 100 and a filter 102, according to an embodiment. In this figure, the protective insulative enclosure 100 includes a padded surface 105 that envelops or encloses the filter 102 and forms a snug fit. This snug fit may securely enclose the filter 102 within the protective insulative enclosure 100, which may minimize gaps or air pockets between the filter 102 and the padded surface 105 that could compromise the efficiency of the protective insulative enclosure 100. The padded material 105 may also stabilize the filter 102 in place, especially during vehicle movement, which may prevent potential damage to the filter 102 or displacement of the filter 102. Additionally, the padded material 105 may provide a protective layer around the filter 105, which acts as a cushion against external impacts or vibrations. Furthermore, the padded material 105 may insulate the filter 102 by creating a barrier around the filter, which in turn protects the filter 102 from extreme temperatures. In this regard, the padded material 105 may aid in maintaining a stable internal environment for the filter 102 and prevent exposure to freezing temperatures or excessive heat.

In one embodiment, the strap 120 may be securely coupled to the protective insulative enclosure 100. A first end of the strap 120 may be fixedly coupled to an outer surface of the sleeve 110 on one side. A second end of the strap 120, positioned opposite the first end, may include a hook-and-loop fastener or patch. The second end of the strap 120 may be configured to couple with a corresponding hook-and-loop fastener patch or surface on the opposite side of the outer surface 112 of the sleeve 210. This configuration allows the strap 120 to span over the sleeve 110 and the enclosed filter 102. The strap 120 can then be wrapped or securely attached to a part of the vehicle body 10, preventing the protective insulative enclosure 100 from dislodging from the filter 102 and effectively securing the protective insulative enclosure 100 in place.

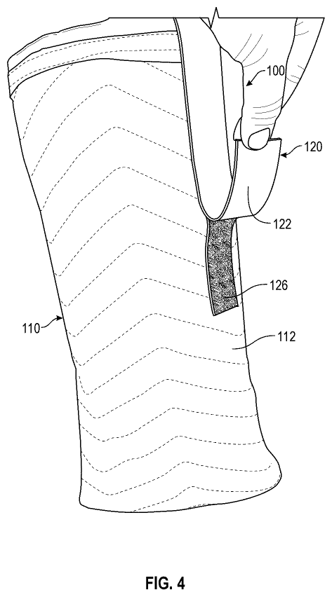

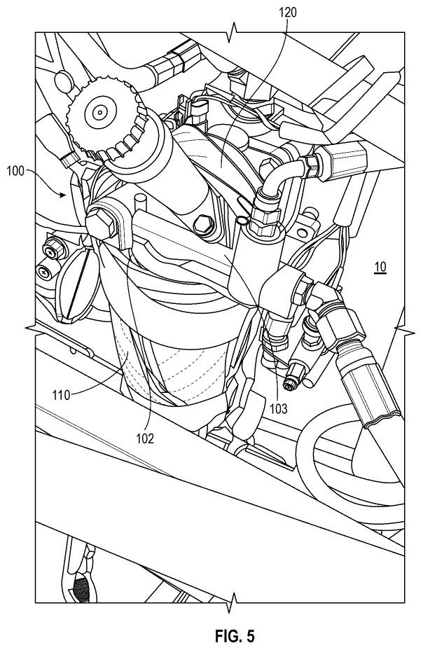

FIG. 4 illustrates a perspective view of a protective insulative enclosure 100 and a strap 120 loosened from the protective insulating enclosure 100, according to an embodiment. The strap 120 may be coupled to an outer surface 112 of a sleeve 110 of the protective insulative enclosure 100. Specifically, an inner surface 122 of the strap 120 includes a hook and loop fastener surface or patch configured to couple with a corresponding hook and loop surface or patch 126 on the outer surface 112 of the sleeve 110. This provides easy and reliable fastening to the outer surface 112 of the sleeve 110. The hook and loop surface or patch on the strap 120 may not extend along the entire length of the strap 120 and may be configured to provide improved grip and handling. By selectively placing or positioning the hook and loop elements along the length of the strap 120, the strap 120 allows for more convenient adjustment and manipulation. For example, the embodiment shown in FIG. 5 allows users to comfortably grip the strap 120 with their hands without impeding the hook and loop surface or patch of the strap 120 or the corresponding hook and loop surface or patch 126 and to easily modify the strap's tension and position while still maintaining a secure and reliable connection to the protective insulative enclosure 100.

FIG. 5 illustrates a protective insulative enclosure 100 enveloping a filter 102 mounted to a vehicle body 10. As shown, the sleeve 110 covers the filter while the strap 120 is coupled to the sleeve 110 and configured to secure the filter 102 therein, preventing inadvertent dislodgment of the sleeve 110 from the filter 102. The strap 120 may be further configured to securely fasten the protective insulative enclosure 100 to the vehicle body 10 by attaching it to a specific part of the vehicle body 10.

In another embodiment, another configuration of the strap attachment is utilized for added flexibility. The first end of the strap 120 may be fixedly coupled to the outer surface of the sleeve 110 on one side, similar to the previous embodiment. However, in this embodiment, the second end of the strap 120 opposite the first end may include a buckle or clasp mechanism. The buckle or clasp mechanism may be configured to securely engage with a corresponding fixture on the opposite side of the outer surface 212 of the sleeve 110. This embodiment provides an adjustable and secure fastening method, allowing users to customize the tightness of the strap 120 around the part of the vehicle body 10, which prevents the protective insulative enclosure 100 from dislodging from the filter 102, even during vehicle movements or vibrations.

In yet another embodiment, the first end of the strap 120 may not be fixedly coupled to the outer surface of the sleeve 110 as in previous embodiments. Instead, the first end of the strap 120 may include an adjustable attachment mechanism, such as a buckle or hook-and-loop fastener. This adjustable mechanism allows users to customize the positioning and tightness of the strap on one or both sides of the sleeve 110. The second end of the strap 120, opposite the first end, may still feature a corresponding fastening element for secure attachment of the second end of the strap 120 to the opposite side of the sleeve 110. This adaptable configuration provides users with additional flexibility in adjusting the strap's tension and positioning. Adjusting the tension of the strap 120 around the part of the vehicle body 10 involves tightening or loosening the strap 120. This configuration allows a user to remove or position the protective insulative enclosure 100 relative to the filter 102 or vehicle body 10 accordingly.

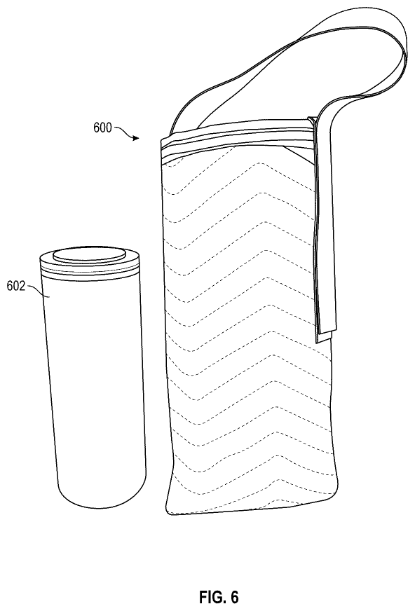

FIG. 6 illustrates a front view of a protective insulative enclosure 600 and a filter 602 adjacent to it, according to an embodiment. This figure provides a visual representation of the configuration and spatial relationship between the protective insulative enclosure 600 and the filter 602. In this embodiment, the protective insulative enclosure 600 is larger than the filter 602, having a larger diameter and height. This configuration may provide increased insulation capacity and enhanced protection for the filter 102 in extreme temperatures. The size of the protective insulative enclosure 600 may accommodate filters of various sizes within the same enclosure. Accordingly, the protective insulative enclosure 600 may adapt to a range of filter dimensions used in different applications. Additionally, the increased surface area of a larger enclosure may enhance the heat resistance of the filter 602.

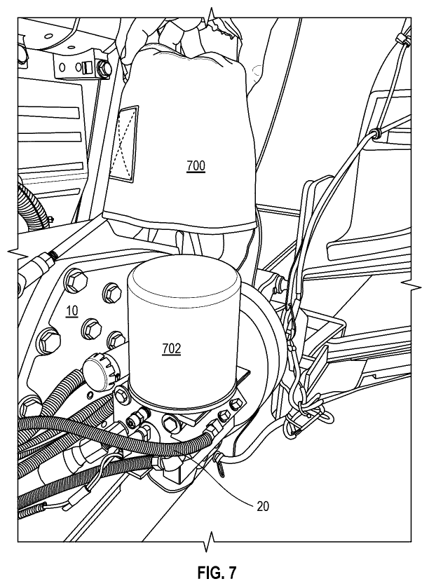

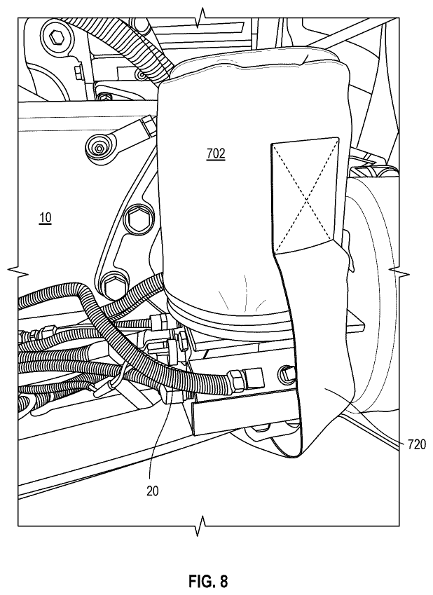

It is to be readily understood that protective insulative enclosures may be made to fit any type of filter in order to protect them from environmental damage, such as from road debris, irrespective of a need, or lack thereof, for thermal insulation. The padding provided by the enclosure, together with any reinforcement, clads any filter with a degree of physical protection. These enclosures may be made for any location of a vehicle, wherever such filter may be located. This is seen in FIGS. 7 and 8, where a protective enclosure 700 is made for an air dryer 702. The strap 720 is made to fit around the air filter mount of the vehicle body 10, avoiding compressed air lines 20.

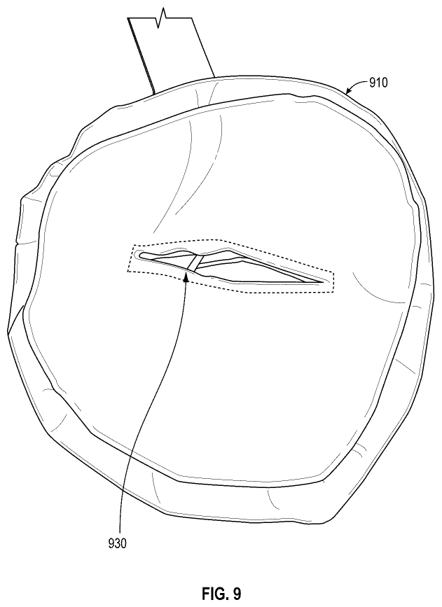

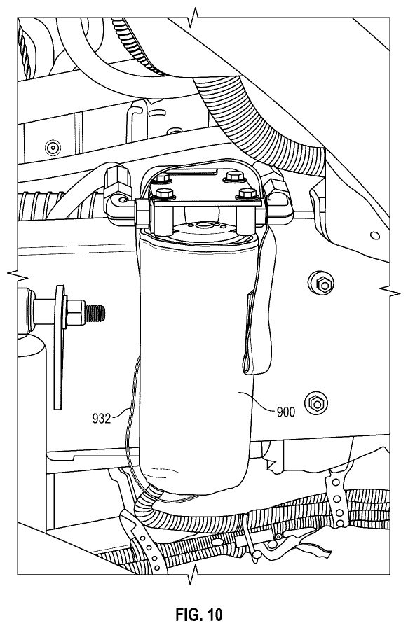

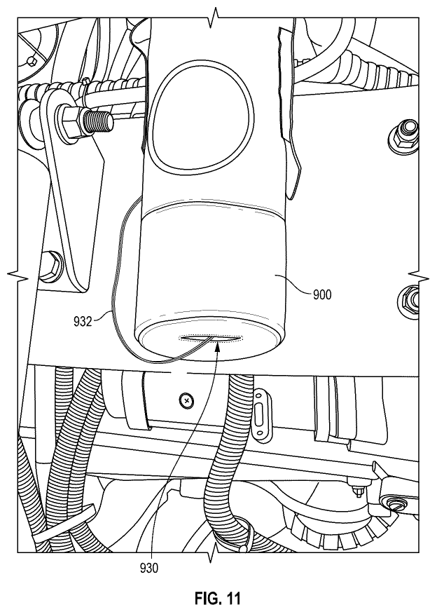

Adaptation of the protective insulative enclosures may also be made to accommodate sensors and wires found on some filters. As shown in FIGS. 9-11, a simple slit 930 in the cap of the sleeve 910 allows a sensor wire 932 passage from the filter to is socket. This slit 930 may be reinforced in any way conceived in the art, including but not limited to surging, reinforced stitching, or structural reinforcement similar to what may be provided the entire sleeve of the protective insulative enclosure (108, FIG. 2). This type of slit may be positioned anywhere on the sleeve 910 that makes sense for a given filter.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e., methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and subcombinations of the various elements, features, functions, and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including elements A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a figure, and where it is clear that the element is duplicated throughout the figure, only one label may be provided for the element, despite multiple instances of the element being present in the figure. Accordingly, other instances in the figure of the element having identical or similar structure and/or function may not have been redundantly labeled. A person having ordinary skill in the art will recognize based on the disclosure herein redundant and/or duplicated elements of the same figure Despite this, redundant labeling may be included where helpful in clarifying the structure of the depicted examples.

The Applicant reserves the right to submit claims directed to combinations and subcombinations of the disclosed examples that are believed to be novel and non-obvious. Examples embodied in other combinations and sub-combinations of features, functions, elements, and/or properties may be claimed through amendment of those claims or presentation of new claims in the present application or in a related application. Such amended or new claims, whether they are directed to the same example or a different example and whether they are different, broader, narrower, or equal in scope to the original claims, are to be considered within the subject matter of the examples described herein.

1. For a filter, a protective insulative enclosure comprising:
a sleeve configured to enclose the filter; and,
a strap coupled to the sleeve, together the sleeve and strap forming a housing, wherein the sleeve comprises an insulated material and the strap is configured to prevent inadvertent dislodgment of the sleeve from the filter by securely fastening the protective insulative enclosure about the filter to a specific part of a vehicle body.

2. The protective insulative enclosure of claim 1, further comprising a reinforcing structure.

3. The protective insulative enclosure of claim 2, the reinforcing structure being resident within the sleeve.

4. The protective insulative enclosure of claim 1, the strap being removably coupled on at least one end of the strap.

5. The protective insulative enclosure of claim 4, the at least one removable end of the strap being selectively secured with a hook and loop fastener.

6. The protective insulative enclosure of claim 1 further comprising at least one slit within the body of the sleeve to allow intentional passage of objects therethrough.

7. The protective insulative enclosure of claim 1, the sleeve further comprising additional protective material to blunt impacts.
